(19) United States
(12) Patent Application Publication
(10) Pub. No.: US 2006/0187817 A1
(43) Pub. Date: Aug. 24, 2006

(54) Access control for a packet-oriented network, taking into account resilience requirements

(76) Inventors: Joachim Charzinski, Munchen (DE); Michael Menth, Oellingen (DE); Karl Schrodj, Geretsried (DE)

Correspondence Address: Siemens Corporation;Intellectual Property Department, 170 Wood Avenue South, Iselin, NJ, 08830, US

(21) Appl. No.: 10/545,566

(22) PCT Filed: Feb. 6, 2004
(86) PCT No.: PCT/EP04/01118

§ 371 Date: Aug. 12, 2005

(30) Foreign Application Priority Data
Feb. 14, 2003 (DE) 10306292.0

(51) Int. Cl. H04J 3/16; H04L 1/00; H04J 3/22; H04J 1/16; H04L 12/26; H04J 3/14; H04L 12/28; H04L 12/56

(52) U.S. Cl. 370/216; 370/229; 370/465; 370/242; 370/389

(57) ABSTRACT

The invention relates to a method for providing resources for adapting the routing process in response to the failure of a network element in a packet-oriented network. Barring checks that use thresholds are provided to control the volume of traffic in the network. Data packets are barred if their routing would otherwise mean the crossing of a threshold. According to the invention, the thresholds are defined by taking into account failure topologies or possible malfunction scenarios, to ensure that a corresponding malfunction does not lead to an overload in the network. Said definition of the thresholds allows resources to be provided or reserved to all intents and purposes for intercepting malfunctions. The advantage of the invention is that quality criteria can be upheld and quality of service features guaranteed, even during the malfunctions.

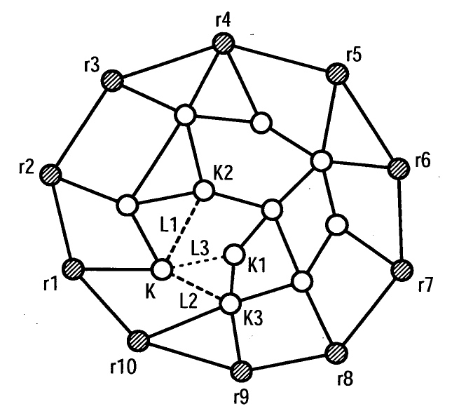

### CROSS REFERENCE TO RELATED APPLICATIONS

This application claims priority to the German application No. 10306292.0, filed Feb. 14, 2003 and to the International Application No. PCT/EP2004/001118, filed Feb. 6, 2004 which are incorporated by reference herein in their entirety.

### FIELD OF INVENTION

The invention relates to a method for providing resources for adapting routing as a reaction to the failure of a network element in a packet-oriented network formed by nodes and links.

### BACKGROUND OF INVENTION

Currently the development of technologies for packet-based networks is a central field of activity for engineers from the areas of network technology, call-processing technology and Internet technologies.

### SUMMARY OF INVENTION

The primary aim of such developments is to enable a packet-oriented network to be used for any services where possible. Traditionally data has been transmitted over packet-oriented networks for which the timing of transmission is not a critical factor, for example the transfer of files or electronic mail. Speech transmission with real-time requirements is conventionally handled using telephone networks with the aid of time division multiplexing. Such networks are also frequently referred to as TDM (Time Division Multiplexing) networks. The laying of networks with high bandwidth or transmission capacity has brought the implementation of image-based services in addition to speech and data transmission into the realms of the possible. Transmission of video information in real time, e.g. within the framework of video-on-demand services or video conferences, will become an important category of services in future networks.

The aim of the development is to be able to execute all services, data-related, voice-related and services relating to video information, via one packet-oriented network. For the different requirements of data transmission within the context of the different services classes of service are usually defined. Transmission with a defined quality of service, particularly for services with real-time requirements, demands a corresponding controller or control for packet transmission over the network. There are a series of terms used in relation to checking or controlling the traffic: traffic management, traffic conditioning, traffic shaping, traffic engineering, policing etc. Different procedures for checking or controlling the traffic of a packet-oriented network are described in the relevant literature.

With ATM (Asynchronous Transfer Mode) networks a reservation is made for each data transmission on the transmission link as a whole. The volume of traffic is restricted by the reservation. To monitor the transmission overload each section of the link is checked. Any discarding of packets is undertaken in accordance with the CLP bit (CLP: Cell Loss Priority) of the packet header.

The Diff-Serv (Differentiated Services) concept is employed with IP (Internet Protocol) networks and aims to provide a better quality of service for service s with high quality requirements by introducing classes of service. A CoS (Class of Service) model is also frequently referred to in this context. The Diff-Serv concept is described in RFCs number 2474 and 2475 published by the IETF. Within the framework of the Diff-Serv concept, a DS (Differentiated Services) field in the IP header of the data packets is used to prioritize packet traffic by setting the DSCP (DS codepoint) parameter. This prioritization is undertaken using a “per hop” resource allocation, i.e. the packets are handled differently at the nodes depending on the class of service set in the DS field by the DSCP parameter. The checking or control of the traffic is also undertaken in accordance with the classes or service. The Diff-Serv concept leads to privileged handling of the traffic of prioritized classes of service, but not to reliable control of the volume of traffic.

Another approach to transmission in relation to a quality of service over IP networks is provided by the RSVP (resource reservation protocol). This protocol is a reservation protocol, with the aid of which bandwidth is reserved along a path. A quality of service (QoS) transmission can then be undertaken via this path. The RSVP protocol is used together with the MPLS (multi protocol label switching) protocol which makes virtual paths over IP networks possible. For a guarantee of QoS transmission the volume of traffic is checked as a rule along the path and restricted if necessary. By introducing paths however much of the original flexibility of IP networks is lost.

Central to guarantees of transmission quality parameters or class of service features is efficient checking of the traffic. As well as prevention of overloads, the reaction of the networks to malfunctions, e.g. failure of a connection section (generally referred to in specialist networks as a link) or of a router or node are other decisive factors as to whether quality-of-service features—above all in relation to data traffic under real-time conditions—can be adhered to. The network should be equipped with mechanisms and resources for fast reaction to malfunctions. Technical literature frequently refers to this characteristic of the network by the term resilience.

An object of the invention is to specify a method for providing resources to adapt routing in the event of malfunctions in a packet-oriented network.

The object is achieved by the claims.

The invention considers a network which provides access control or barring checks at least for data packets of one class of service. The barring checks are undertaken by imposing limits or budgets for traffic to be transmitted. Within the framework of barring checking a check is made for example as to whether allowing a group of data packets or a flow would lead to a limits being exceeded. If this test or this check yields a negative result, the transmission of the corresponding group of data packets or of the corresponding flow is rejected. Barring checks can be conducted for the entire transmission traffic or also for just one class of traffic, with the desired transmission quality to be achieved by the barring check then only being able to be provided for the corresponding traffic class. The access control can relate to the network as a whole or to individual links. Examples for protocols which include link-related barring checks are the ATM method or the Integrated Services concept, which is used for IP networks. The aim of access control is to improve the transmission quality for the data packets of the traffic class. The criteria for access control are chosen so that the transmission of the data packets of the traffic class meets quality criteria. This can amount to a fixed reservation of bandwidth on individual links (e.g. ATM, MPLS), can be restricted to prioritizing of traffic classes (e.g. Diff-Serv) or can mean controlling the overall traffic volume in the network and its distribution or balancing out for the purposes of adhering to quality-of-service features. The latter case can be implemented with the choice of limits for access control presented below

The invention is based on the idea of taking into account at least one possible malfunction when defining the limits for access control. The limits are determined in accordance with a quality criterion such that this quality criterion is adhered to even if a fault occurs. This criterion can be determined as follows:

Routing within the network is adapted to the failure of a network element (e.g. link or router). The adaptation can consist of a very simple reaction such as the discarding of packets. With modern packet-oriented networks there is generally provision for new next hops or new next destination addresses to be computed and the routing tables modified accordingly. Messages about the changed topology of the network are propagated in the network, e.g. by means of link state messages for frequently used link state protocols. The topology information used for the routing tables of the routers then converges, taking into account the non-availability of the failed network element. Newer methods relate to a fast rerouting of packets which would normally have been transmitted via the failed network element, e.g. by a corresponding insertion or modification of address information in the packet header. In accordance with the invention at least one quality criterion is taken into account for transmission of data packets, e.g. the loss of packets or the packet loss rate, the delay in the transmission of packet or the jitter. Limit values for barring checks are determined for the network topology resulting from the failure of the network element—referred to below as the failure topology—depending on the reaction provided in the network to the failure, such that the quality criterion is adhered to even if a network element fails. Routing and error correction mechanisms are taken into account in this case. Possible routing methods or routing mechanisms are for example classical single path routing such as OSPF (open shortest path first), multiple routing such as OSPF/ECMP (open shortest path first/equal cost multipath) or MPLS fast rerouting. For example determination of the limit values makes it possible to ensure that there is sufficient bandwidth available for fast rerouting or rerouting of the packets provided in the network. In these cases the quality criterion would be the reserve bandwidth or the delay times of the packets rerouted in the event of an error. The limit values can for example be determined in a central or in a distributed control entity, e.g. in a control server of the network and for example determined by simulation of the traffic flows for the failure topology depending on the limit values.

The limits for access control are set in accordance with the specific limit values which take account of the failure topology. This determination or choice of the limits corresponds to provision of resources for the failure of the network element in order to guarantee maintenance of the quality criterion even in this case.

The advantage of the invention is that the quality criterion is fulfilled even in the event of a fault. It is important above all with regard to quality-of-service features for real-time traffic to be able to guarantee these independently of faults.

The method in accordance with the invention can be expanded to the point at which limit values are defined for a plurality of failure topologies and in each case the minimum of a limit value is used as the limit for access control. In this way the quality criterion or the quality criteria are guaranteed for all cases of faults covered by a plurality of failure topologies. There are many options for choosing selection topologies, e.g.
All topologies are considered in which an individual link has failed.
In addition all topologies are considered in which a larger number of links have failed simultaneously (e.g. 2 or 3 links).
As an alternative or in addition all topologies are considered in which a node has failed in each case.
oAs an alternative or in addition all topologies are considered in which a number of nodes have failed.
The failure topologies to be considered are selected with reference to other topological criteria, e.g. do the failures of such links which are used for routing to especially many destinations also have to be taken into consideration in any event for multiple failures.
The failure topologies to be considered are selected on the basis of the link capacities, e.g. do links with high capacity also have to be taken into consideration with multiple failures, but not links with lower capacity.
the failure topologies to be considered are determined on the basis of the number of connected subscribers, planned or measured traffic volume (e.g. nodes with many subscribers must be taken into account but not nodes with few subscribers).

In accordance with a further development the network operator can select the above-mentioned criteria for failure topologies (e.g. at a management interface or user interface). Traffic distribution weights, i.e. a criterion as to what proportion of the traffic will be forwarded on which next hop, can be incorporated into the calculation or determination of the limit values or budgets. Alternatively these traffic weights can be assumed to be all the same, i.e. for each destination the distribution weight at a node for the next hops is the same as the reverse value of the number of next hops to this destination. Another alternative is to assume these distribution weights as all being one (very conservative approach).

For connection by means of dual homing (two lines from different network marginal nodes to a subscriber or subscriber network) either a predetermined traffic distribution can be considered or the reservation can basically be calculated for the two lines based on the budgets or limits.

In accordance with a further development the inventive method is supplemented by resilience priorities. In accordance with these priorities two different traffic classes can be identified for example. For each budget two different values B_R (protected) and B_E (unprotected) are computed. B_E is only computed on the basis of the original topology (without failures), B_R is computed according to the method described above covering all failure topologies to be considered and is thus always less than or equal to B_E. Packets include (e.g. in an additional bit in the TOS/DSCP field or a specific TOS-DSCP value according to the Diff-Serv method, which provides a type of service (TOS) field for the differentiated services codepoint (DSCP)), an identifier which specifies whether in the case of a failure the traffic must be further transported or not. Protected reservations are calculated for both budgets, unprotected only for B_E.

This mechanism can also be used for creating a number of classes of resilience priorities or traffic classes by using different failure topologies as a basis. In this case for example the budgets B_T can be computed for an especially protected class such that all failure topologies with single or multiple link failures as well as all single node failures are considered. A second “normally protected” class is based on budgets which only take account of single link failures and a third (unprotected) class uses budgets which were only determined on the basis of the original topology.

Such resilience priorities can be directly coupled with scheduling priorities for traffic classes in the network nodes.

In accordance with a further development the following types of limits can be employed for permissibility checking:

Limits for a maximum traffic volume between a network ingress node and an egress node in each case.

Limits for a maximum traffic volume of traffic coming into the network at an ingress node and for a maximum traffic volume of traffic leaving at an egress node.

Limits for a maximum volume of traffic arriving at an ingress node and routed over a link as well as a maximum volume of traffic leaving at an egress node and routed over a link.

These different types of limits can also be combined with one another. For a transmission under real-time conditions over a packet-oriented network all flows of at least one traffic class can be subjected at the edge of the network to a barring check with one of the limits described above. In this way the entire volume of traffic is checked and can be matched to the available bandwidth.

The role of the inventive method for data transmission in compliance with quality-of-service features is explained in greater detail below within the framework of an exemplary embodiment with reference to a FIGURE.

### DETAILED DESCRIPTION OF INVENTION

For the sake of simplicity the method is only shown for one failure topology which is the result of the failure of a link. Using corresponding methods for a plurality of failure topologies the network can be protected against all probable fault cases.

The FIGURE shows a network made up of nodes and links. In this case the edge nodes r1 to r10 are identified by solid circles. The internal nodes are indicated by non-solid circles. Links are illustrated by connectors between nodes. For the network different types of peripheral conditions can be defined which guarantee barring checks at the margin of the network. The type of peripheral conditions can for example be selected to depend on the topology of the network. The form of the peripheral conditions helps to decide on the blocking probabilities for which an overload situation occurs in accordance with the inventive method. Possible peripheral conditions are:
1. Limits for the traffic which is transmitted between two marginal nodes, i.e. one limit value each for a pair (ri,rj), j,i^{a} {1, . . . , 10}, produced by two marginal nodes.
2. Limit values for all ingress and egress nodes. If we assume that all marginal nodes ri, i^{a} {1, . . . ,10} are both ingress and egress nodes, this would produce 20 limit values, with two limit values in each case, one ingress limit value and one egress limit value, being assigned to a marginal node. For a flow which is to be transmitted from the ingress node ri to the egress node rj a check would then be made on whether the node would exceed the ingress limit for ri or the egress limit for rj. Exceeding the limit would result in rejection.
3. Ingress and egress limit values as for 2., but for all links of the network. This means that for each link L there would be two limits per marginal node in each case. For the transmission of a flow from node ri to node rj the ingress limits of ri and the egress limits of rj would be checked which relate to links over which the flow is to be transmitted.

To simplify matters the explanation belows assumes the form of limits described in 1. above.

the failure topologies considered would result from failure of the link L3 shown by a dotted line. The network reacts to this by fast rerouting of the data packets to be transmitted over the link L3. Thus for example packets routed from the node K to the node K1 over the link L can be routed directly after notification from the node K about the link failure over the links L1 and L2, shown by dashed lines, to the nodes K2 and K3. This can for example be achieved by the address for routing to the next hops being explicitly specified in the headers of the data packets. This is intended to prevent

packets getting lost and

long delays occurring in the routing of the packets.

Ideally service quality features of real-time traffic can be guaranteed by fast rerouting even in the event of an error. To do this however it must be ensured that the additional traffic caused by the rerouting does not lead to an overload. In accordance with the invention the limits for the access control are set so that this is not the case. In particular an overload on the links L1 and L2 is avoided.

For the presentation below the following variables are introduced:

BBB(ri,rj): the limit for the volume of traffic between the ingress node ri and the egress node rj c(L): the volume of traffic on the link L aV(ri,rj,L): the proportional volume of traffic over the link L of the overall volume of traffic between the ingress node ri and the egress node rj

On the basis of traffic models or simulations and measurements, the values for the failure topology considered can define the values of proportional volume of traffic aV(ri,rj,L) for all (non-failed) links L.

For each of the links L the following then applies:
C(L)=ΣBBB(ri,rj)·aV(ri,rj,L), (1)
where the sum covers all ingress nodes ri and egress nodes rj. The equation (1) relates the parameters c(L) to the limits BBB(ri,rj). The limits BBB(ri,rj) can now be defined so that for all links L (with the exception of the malfunctioning link L3 of course) the volume of traffic C(L) does not exceed the available bandwidth on the relevant link L. In particular an overload can be avoided for the links L1 and L2 by fixing the limits BBB(ri,rj) by means of equation (1). In the result the limits BBB(ri,rj) are fixed by considering the overload situation in equation (1) so low that sufficient bandwidth is available on the links L1 and L2 for a fast error reaction. A corresponding method can be employed for a plurality of failure topologies, e.g. for all simple link failures. In this case the minimum of the limits BBB(ri,rj) set for the different failure topologies is used.

The peripheral conditions can be combined with other peripheral conditions which are used for additional barring checks, e.g. with the peripheral conditions of type 2:

For an embodiment with two additional barring checks the following mathematical relationship can be formulated. The above definitions apply. In addition let

Ingress(ri): be the limit value for the traffic over the ingress node ri,

Egress(rj): be the limit value for the traffic over the egress node rj,

δ (ri,rj): be the volume of traffic between the ingress node ri and the egress node rj.

The following inequalities can now be formulated:

For all i the following applies
Σδ(ri,rj)≦Ingress(ri),sum of all j. (2)
For all j the following applies
Σδ(ri,rj)≦Egress(rj),sum of all i. (3)
for all pairs (i,j) the following applies
δ(ri,rj)≦BBB(ri,rj). (4)
for all links L with the exception of the failed link the following applies:
c(L)=Σδ(ri,rj)·aV(ri,rj,L),sum of all i and j. (5)

With the aid of the simplex algorithm, for predetermined values of Ingress(ri), Egress(rj) and BBB(ri,rj) the maximum c(L) can be computed which fulfills the inequalities (2) to (4). Conversely for a set of limits or limit values Ingress(ri), Egress(rj) and BBB(ri,rj) a check can be made as to whether an impermissibly high load can occur on a link L (e.g. link L1 or L2). In this case a modification of the limits or limit values to counter the situation can be undertaken.

1.-12. (canceled)

13. A method of providing resources for adapting of a routing of data packets in a packet-oriented network having network elements including nodes and links, the method provided for the case of failure of a network element, the method comprising:
determining an adapted routing through the network of a group of data packets in case of failure of a network element;
determining limit values for an admission check based on at least one transmission quality criterion, the transmission quality criterion representing a transmission quality of the group of data packets routed through the network according to the determined adapted routing;
deriving an admission limit for the admission check from the limit values;
executing the admission check relative to the group of data packets by comparing an attribute of the group of data packets to the derived admission limit; and
providing resources for an adapted routing of the group of data packets within the network only if the attribute does not violate the derived admission limit.

14. The method in accordance with claim 13, wherein the network element is a link or a node of the network.

15. The method in accordance with claim 13, further comprising:
determining a plurality of failure topologies of the network, the plurality of failure topologies corresponding to a plurality of non-disturbed sub-networks of the network through which the group of data packets could be alternatively routed in case of failure of the network element, wherein the transmission quality criterion is adhered to relative to each determined failure topology;
determining a limit value relative to each determined failure topology; and
setting the admission limit to a minimum value derived from the limit values determined for each determined failure topology.

16. The method in accordance with claim 15, wherein the plurality of failure topologies include a plurality of failure topologies each corresponding to the network having only one disturbed link.

17. The method in accordance with claim 15, wherein the plurality of failure topologies include a plurality of failure topologies each corresponding to the network having only one disturbed node.

18. The method in accordance with one of the claims 15, wherein the plurality of failure topologies include a plurality of failure topologies each corresponding to the network having more than one disturbed network element.

19. The method in accordance with claim 15, wherein
data packets to be routed through the network are divided into a plurality of traffic classes,
a first plurality of admission limits is determined relative to a plurality of failure topologies,
a second plurality of admission limits is determined disregarding any failure topology,
executing the admission check including the first plurality of admission limits relative to data packets assigned to a first traffic class, and
executing the admission check including the second plurality of admission limits relative to data packets assigned to a second traffic class.

20. The method in accordance with claim 15, wherein
data packets to be routed through the network are divided into a plurality of traffic classes,
a first plurality of admission limits is determined relative to a first plurality of failure topologies,
a second plurality of admission limits is determined relative to a second plurality of failure topologies,
executing the admission check including the first plurality of admission limits relative to data packets assigned to a first traffic class, and
executing the admission check including the second plurality of admission limits relative to data packets assigned to a second traffic class.

21. The method in accordance with claim 13, wherein the admission limit represents a maximum traffic volume between an ingress node and an egress node of the network.

22. The method in accordance with claim 13, wherein the admission limit represents a maximum traffic volume for traffic entering the network at an ingress node and a maximum traffic volume leaving the network at an egress node.

23. The method in accordance with claim 13, wherein the admission limit represents a maximum traffic volume for traffic entering the network at an ingress node and routed over a link and to a maximum traffic volume for traffic leaving at an egress node and routed over a link.

24. A router for a packet-oriented network having network elements including nodes and links, comprising a routing control unit for providing resources for an adapted routing of data packets through the network in case of failure of a network element, wherein the router is configured to:
determine an adapted routing through the network of a group of data packets in case of failure of a network element;
determine limit values for an admission check based on at least one transmission quality criterion, the transmission quality criterion representing a transmission quality of the group of data packets routed through the network according to the determined adapted routing;
derive an admission limit for the admission check from the limit values;
execute the admission check relative to the group of data packets by comparing an attribute of the group of data packets to the derived admission limit; and
provide resources for an adapted routing of the group of data packets within the network only if the attribute does not violate the derived admission limit.
